(19) United States
(12) Patent Application Publication
(10) Pub. No.: US 2025/0304462 A1
(43) Pub. Date: Oct. 2, 2025

(54) METAL OXIDE FINE PARTICLES AND DISPERSION OF METAL OXIDE FINE PARTICLES

(71) Applicant: MITSUBISHI MATERIALS CORPORATION, Tokyo (JP)

(72) Inventors: Megumi Tomoyama, Naka-shi (JP); Akihiro Nohara, Naka-shi (JP)

(73) Assignee: MITSUBISHI MATERIALS CORPORATION, Tokyo (JP)

(21) Appl. No.: 18/934,833

(22) Filed: Nov. 1, 2024

(30) Foreign Application Priority Data
Mar. 29, 2024 (JP) 2024-055333

(51) Int. Cl. C01G 19/02; C01G 15/00

(52) U.S. Cl. CPC C01G 19/02; C01G 15/00; C01P 2006/22; C01P 2006/60

(57) ABSTRACT

In an aspect of metal oxide fine particles, with regard to a transmission spectrum measured under conditions where the metal oxide fine particles are dispersed in a dispersion medium at a concentration of 0.7 mass % to prepare a dispersion and the dispersion is put into a 1 mm cell, an inclination k₁ obtained by linearly approximating the transmission spectrum in a wavelength range of 290 nm to 330 nm by a least squares method is in a range of 0.90 or more and 1.60 or less.

### BACKGROUND OF THE INVENTION

### Field of the Invention

The present invention relates to metal oxide fine particles and a dispersion of metal oxide fine particles for depositing a metal oxide film used as a transparent conducting film, a heat shielding film, or the like.

The present application claims priority on Japanese Patent Application No. 2024-055333 filed on Mar. 29, 2024, the content of which is incorporated herein by reference.

### Description of Related Art

Window materials for vehicles such as automobiles, trains, marine vessels, construction materials, and airplanes, window materials for houses, and glass plates used for showcases may be required to have, in addition to transparency, conductive properties for prevention of static charge and infrared cut characteristics.

In addition, transparent conducting films are used as wiring in liquid crystal displays, organic light-emitting diode displays, touch panels, and the like. The transparent conducting films are required to have a high light transmittance in a visible light region and a low electrical resistance.

As materials for such applications, for example, metal oxides such as a tin-doped indium oxide powder, an antimony-doped tin oxide powder, a cesium-doped tungsten oxide powder, and an aluminum-doped zinc oxide powder are known as shown in Japanese Unexamined Patent Application, First Publication No. 2004-075510, Japanese Unexamined Patent Application, First Publication No. 2008-297414, and Japanese Patent No. 6950691.

### SUMMARY OF THE INVENTION

In the metal oxide powders disclosed in Japanese Unexamined Patent Application, First Publication No. 2004-075510, Japanese Unexamined Patent Application, First Publication No. 2008-297414, and Japanese Patent No. 6950691, scattering, reflection, and absorption of light occur due to the morphology and composition of particles and the band gap of matrix. Therefore, there was a concern that the transmittance of visible light would decrease.

The present invention has been contrived in view of the above circumstances, and an objective of the present invention is to provide metal oxide fine particles and a dispersion of metal oxide fine particles capable of depositing a metal oxide film having excellent heat shielding characteristics and visible light transmission properties.

In order to solve the above-described problems, the inventors of the present invention conducted intensive studies, and as a result, they found that, metal oxide fine particles synthesized in a mixed solvent of two or more of a carboxylic acid, an amine, and water have low infrared light transmission properties and sufficiently high visible light transmission properties, and it is possible to deposit a metal oxide film having excellent heat shielding characteristics and visible light transmission properties.

In addition, they found that, in a transmission spectrum of a dispersion of metal oxide fine particles in which the above-described metal oxide fine particles are dispersed in a dispersion medium, the transmittance rapidly increases in a visible light region.

The transmission spectrum is a graph in which a vertical axis indicates a transmittance (%T) and a horizontal axis indicates a wavelength (nm). In the measurement of the transmission spectrum, the transmittance of only the dispersion medium is measured and used as a baseline. Specifically, the transmittance (%T) on the vertical axis of the transmission spectrum is a value calculated from the expression of Tₛₐₘₚₗₑ−T_{base} where Tₛₐₘₚₗₑ is a measured transmittance of the dispersion and T_{base} is a measured transmittance of the dispersion medium.

Metal oxide fine particles of Aspect 1 of the present invention have been devised based on the above-described findings, and are characterized in that, with regard to a transmission spectrum measured under conditions where the metal oxide fine particles are dispersed in a dispersion medium at a concentration of 0.7 mass % to prepare a dispersion and the dispersion is put into a 1 mm cell, an inclination k₁ obtained by linearly approximating the transmission spectrum in a wavelength range of 290 nm to 330 nm by a least squares method is in a range of 0.90 or more and 1.60 or less.

According to the metal oxide fine particles of Aspect 1 of the present invention, in a transmission spectrum of a dispersion in which the metal oxide fine particles are dispersed in a dispersion medium at a concentration of 0.7 mass %, an inclination k₁ obtained by linearly approximating the transmission spectrum in a wavelength range of 290 nm to 330 nm by the least squares method is in a range of 0.90 or more and 1.60 or less. Therefore, transmission properties are rapidly improved in a visible light region and excellent visible light transmission properties are exhibited.

Therefore, it is possible to deposit a metal oxide film having excellent heat shielding characteristics and visible light transmission properties.

Metal oxide fine particles of Aspect 2 of the present invention are characterized in that, with regard to a transmission spectrum measured under conditions where the metal oxide fine particles are dispersed in a dispersion medium at a concentration of 0.7 mass % to prepare a dispersion and the dispersion is put into a 1 mm cell, an inclination k₂ obtained by linearly approximating the transmission spectrum in a wavelength range of 310 nm to 330 nm by a least squares method is in a range of 0.95 or more and 2.30 or less.

According to the metal oxide fine particles of Aspect 2 of the present invention, in a transmission spectrum of a dispersion in which the metal oxide fine particles are dispersed in a dispersion medium at a concentration of 0.7 mass %, an inclination k₂ obtained by linearly approximating the transmission spectrum in a wavelength range of 310 nm to 330 nm by the least squares method is in a range of 0.95 or more and 2.30 or less. Therefore, transmission properties are rapidly improved in a visible light region and excellent visible light transmission properties are exhibited.

Therefore, it is possible to deposit a metal oxide film having excellent heat shielding characteristics and visible light transmission properties.

Metal oxide fine particles of Aspect 3 of the present invention are characterized in that, in the metal oxide fine particles of Aspect 1 or 2 of the present invention, a primary particle diameter is 50 nm or less.

According to the metal oxide fine particles of Aspect 3 of the present invention, since the primary particle diameter is 50 nm or less, scattering of visible light can be sufficiently suppressed and visible light transmission properties of a deposited metal oxide film can be further improved.

Metal oxide fine particles of Aspect 4 of the present invention are characterized in that, in the metal oxide fine particles of any one of Aspects 1 to 3 of the present invention, the metal oxide fine particles consist of a tin oxide or a tin oxide containing antimony.

Metal oxide fine particles of Aspect 5 of the present invention are characterized in that, in the metal oxide fine particles of any one of Aspects 1 to 3 of the present invention, the metal oxide fine particles consist of an indium oxide or an indium oxide containing tin.

A dispersion of metal oxide fine particles of Aspect 6 of the present invention is characterized in that the dispersion includes the metal oxide fine particles of any one of Aspects 1 to 5 of the present invention and a dispersion medium in which the metal oxide fine particles are dispersed.

According to the dispersion of metal oxide fine particles of Aspect 6 of the present invention, the metal oxide fine particles of any one of Aspects 1 to 5 of the present invention are dispersed. Therefore, it is possible to deposit a metal oxide film having excellent heat shielding characteristics and visible light transmission properties.

A method for producing a metal oxide film of Aspect 7 of the present invention is characterized in that the method includes an application step of applying the dispersion of metal oxide fine particles of Aspect 6 of the present invention.

According to the method for producing a metal oxide film of Aspect 7 of the present invention, the application step of applying the dispersion of metal oxide fine particles of Aspect 6 of the present invention is included. Therefore, it is possible to deposit a metal oxide film having excellent heat shielding characteristics and visible light transmission properties.

According to the aspects of the present invention, it is possible to provide metal oxide fine particles and a dispersion of metal oxide fine particles capable of depositing a metal oxide film having excellent heat shielding characteristics and visible light transmission properties.

### DETAILED DESCRIPTION OF THE INVENTION

Hereinafter, metal oxide fine particles, a dispersion of metal oxide fine particles, and a method for producing a metal oxide film according to an embodiment of the present invention will be described. The embodiments shown below are specifically described for better understanding of the features of the invention, and do not limit the present invention unless otherwise specified.

The metal oxide fine particles and the dispersion of metal oxide fine particles according to the embodiment of the present invention are used, for example, in a step of depositing a metal oxide film which is used as a heat shielding film of a glass material, a transparent conducting film, or the like.

In the above-described metal oxide film, it is necessary to achieve both infrared cut characteristics and high visible light transmission properties in order to ensure heat shielding properties and transparency.

In metal oxide fine particles according to a first embodiment of the present invention, with regard to a transmission spectrum measured under conditions where the metal oxide fine particles are dispersed in a dispersion medium at a concentration of 0.7 mass % to prepare a dispersion and the dispersion is put into a 1 mm cell, an inclination k₁ obtained by linearly approximating the transmission spectrum in a wavelength range of 290 nm to 330 nm by a least squares method is set to be in a range of 0.90 or more and 1.60 or less.

In a case where the inclination k₁ of the transmission spectrum in a near ultraviolet to visible light region which is in a wavelength range of 290 nm to 330 nm is 0.90 or more and 1.60 or less, transmission properties rapidly increase in this region and particularly excellent visible light transmission properties are exhibited.

The lower limit of the inclination k₁ is preferably 0.93 or more, and more preferably 1.00 or more.

In addition, in metal oxide fine particles according to a second embodiment of the present invention, with regard to a transmission spectrum measured under conditions where the metal oxide fine particles are dispersed in a dispersion medium at a concentration of 0.7 mass % to prepare a dispersion and the dispersion is put into a 1 mm cell, an inclination k₂ obtained by linearly approximating the transmission spectrum in a wavelength range of 310 nm to 330 nm by a least squares method is set to be in a range of 0.95 or more and 2.30 or less.

In a case where the inclination k₂ of the transmission spectrum in a visible light region which is in a wavelength range of 310 nm to 330 nm is 0.95 or more and 2.30 or less, transmission properties rapidly increase in this region and particularly excellent visible light transmission properties are exhibited.

The lower limit of the inclination k₂ is preferably 0.96 or more, and more preferably 1.00 or more.

As the above-described dispersion medium, it is preferable to appropriately select a dispersion medium in which the metal oxide fine particles can be sufficiently dispersed. For example, in a case where the metal oxide fine particles are sufficiently dispersed in water, water may be used as a dispersion medium to measure a transmission spectrum of an aqueous dispersion in which the metal oxide fine particles are dispersed at a concentration of 0.7 mass %. In addition, in case where the metal oxide fine particles are sufficiently dispersed in toluene, toluene may be used as a dispersion medium to measure a transmission spectrum of a toluene dispersion in which the metal oxide fine particles are dispersed at a concentration of 0.7 mass %. The dispersion medium may consist of one material or may consist of a mixture of two or more materials.

In the metal oxide fine particles according to the present embodiment, the primary particle diameter is preferably in a range of 2.0 nm or more and 50 nm or less.

In a case where the primary particle diameter of the metal oxide fine particles is 50 nm or less which is relatively small, scattering of visible light by the metal oxide fine particles can be suppressed and visible light transmission properties can be further improved.

The upper limit of the primary particle diameter of the metal oxide fine particles is more preferably set to be 20 nm or less. In addition, the lower limit of the primary particle diameter of the metal oxide fine particles is not particularly limited, and is substantially 1 nm or more, and preferably 2.0 nm or more.

As a metal oxide constituting the metal oxide fine particles, a tin oxide, a tin oxide containing antimony (antimony-doped tin oxide), an indium oxide, an indium oxide containing tin (tin-doped indium oxide), and the like can be used.

In a tin oxide containing antimony (antimony-doped tin oxide), the amount of antimony is preferably in a range of more than 0 atom % and 30 atom % or less with respect to tin.

In an indium oxide containing tin (tin-doped indium oxide), the amount of tin is preferably in a range of more than 0 atom % and 30 atom % or less with respect to indium.

In the dispersion of metal oxide fine particles according to the present embodiment, the metal oxide fine particles of the present embodiment are dispersed in a dispersion medium.

In the dispersion of metal oxide fine particles according to the present embodiment, for example, water, ethanol, isopropanol, toluene, and the like can be used as the dispersion medium.

In addition, in the dispersion of metal oxide fine particles according to the present embodiment, the amount of the metal oxide fine particles of the present embodiment is preferably in a range of 0.1 mass % or more and 80 mass % or less.

The metal oxide fine particles according to the present embodiment can be produced by synthesizing metal oxide fine particles in a mixed solvent obtained by mixing two or more selected from a carboxylic acid, an amine, and water.

For example, the metal oxide fine particles according to the present embodiment consisting of antimony-doped tin oxide can be produced by a method which includes: heating a mixed solvent of a carboxylic acid (for example, acetic acid) and an amine (for example, monoethanolamine); mixing a tin raw material (for example, tin (IV) chloride pentahydrate) and an antimony raw material (for example, antimony (III) chloride) in the mixed solvent; and performing heating treatment (heating temperature: 100° C. or higher and 300° C. or lower, holding time: 10 minutes or longer).

In addition, the metal oxide fine particles according to the present embodiment consisting of tin-doped indium oxide can be produced by a method which includes: mixing an indium raw material (for example, indium octylate) and a tin raw material (for example, tin(II) octylate) in a mixed solvent of an amine (for example, oleylamine), water, and an octyl ether; and performing heating treatment.

It is presumed that the primary particle diameter of the metal oxide fine particles and the valences of the metal elements constituting the metal oxide are controlled due to the producing method, and the primary particle diameter and the valences of the metal elements contribute to the values of k₁ and k₂. However, it is very difficult to measure a difference in valence between the metal elements in the metal oxide fine particles having a small primary particle diameter.

The dispersion of metal oxide fine particles according to the present embodiment can be produced by dispersing the metal oxide fine particles according to the present embodiment in a dispersion medium.

The method for producing a metal oxide film according to the present embodiment includes an application step of applying the dispersion of metal oxide fine particles of the present embodiment. For example, the dispersion of metal oxide fine particles is applied to a substrate by a spin coating method or the like, and then the substrate is heated to dry the coating film. For example, 0.4 ml of toluene is added dropwise onto a glass substrate while rotating the glass substrate at a rotation speed of 1,000 rpm by a spin coater. Immediately after that, 0.4 ml of the dispersion of metal oxide fine particles is added dropwise onto the glass substrate. Next, the glass substrate is placed on a hot plate to dry the coating film at 100° C. for 10 minutes. Accordingly, a metal oxide film is deposited.

According to the metal oxide fine particles of the first embodiment of the present invention having the above-described configuration, in a transmission spectrum of a dispersion in which the metal oxide fine particles are dispersed in a dispersion medium at a concentration of 0.7 mass %, the inclination k₁ obtained by linearly approximating the transmission spectrum in a wavelength range of 290 nm to 330 nm by the least squares method is set to be in a range of 0.90 or more and 1.60 or less. Therefore, transmission properties are rapidly improved in the visible light region and excellent visible light transmission properties are exhibited while infrared light is not transmitted.

Therefore, it is possible to deposit a metal oxide film having excellent heat shielding characteristics and visible light transmission properties.

According to the metal oxide fine particles of the second embodiment of the present invention, in a transmission spectrum of a dispersion in which the metal oxide fine particles are dispersed in a dispersion medium at a concentration of 0.7 mass %, the inclination k2 obtained by linearly approximating the transmission spectrum in a wavelength range of 310 nm to 330 nm by the least squares method is set to be in a range of 0.95 or more and 2.30 or less. Therefore, transmission properties are rapidly improved in the visible light region and excellent visible light transmission properties are exhibited while infrared light is not transmitted.

Therefore, it is possible to deposit a metal oxide film having excellent heat shielding characteristics and visible light transmission properties.

In the metal oxide fine particles of the present embodiment, in a case where the primary particle diameter is 50 nm or less, scattering of visible light can be sufficiently suppressed, and the visible light transmission properties of the deposited metal oxide film can be further improved.

In a case where the metal oxide fine particles of the present embodiment consist of a tin oxide or a tin oxide containing antimony, it is possible to deposit a metal oxide film having excellent heat shielding characteristics and visible light transmission properties.

In a case where the metal oxide fine particles of the present embodiment consist of an indium oxide or an indium oxide containing tin, it is possible to deposit a metal oxide film having excellent heat shielding characteristics and visible light transmission properties.

According to the dispersion of metal oxide fine particles of the present embodiment, since the metal oxide fine particles of the present embodiment are dispersed in the dispersion medium, it is possible to deposit a metal oxide film having excellent heat shielding characteristics and visible light transmission properties.

Although one embodiment of the present invention is described above, the present invention is not limited thereto and appropriate modification is possible in a range not departing from the features of the invention.

### EXAMPLES

Confirmation experiments performed to confirm the effectiveness of the present invention will be described.

### Invention Examples 1 to 11

One of carboxylic acids and one of amines shown in Table 1 were mixed to prepare a mixed solvent, and in a state in which the mixed solvent was heated to 80° C., a tin raw material and an antimony raw material shown in Table 1 were added thereto and stirred. Thereby, a raw material suspension was obtained.

The raw material suspension was subjected to heating treatment under conditions shown in Table 1 to produce metal oxide fine particles of antimony-doped tin oxide (doping concentration: 10 atom %).

TABLE 1

| Synthetic Solvent | | Raw Material | |
|---|---|---|---|
| Carboxylic Acid | Amine | Tin Raw Material | Antimony Raw Material |

| | | | Amount | | Amount | | Amount | | Amount |
|---|---|---|---|---|---|---|---|---|---|
| | | Material | (ml) | Material | (ml) | Material | (mmol) | Material | (mmol) |
| Invention | 1 | Acetic | 36 | Monoethanolamine | 24 | Tin(IV) | 2.7 | Antimony(III) | 0.3 |
| Example | | Acid | | | | Chloride•Pentahydrate | | Chloride | |
| | 2 | Acetic | 40 | Monoethanolamine | 20 | Tin(IV) | 2.7 | Antimony(III) | 0.3 |
| | | Acid | | | | Chloride•Pentahydrate | | Chloride | |
| | 3 | Acetic | 50 | Monoethanolamine | 10 | Tin(IV) | 2.7 | Antimony(III) | 0.3 |
| | | Acid | | | | Chloride•Pentahydrate | | Chloride | |
| | 4 | Acetic | 36 | Triethanolamine | 24 | Tin(IV) | 2.7 | Antimony(III) | 0.3 |
| | | Acid | | | | Chloride•Pentahydrate | | Chloride | |
| | 5 | Acetic | 40 | Triethanolamine | 20 | Tin(IV) | 2.7 | Antimony(III) | 0.3 |
| | | Acid | | | | Chloride•Pentahydrate | | Chloride | |
| | 6 | Acetic | 50 | Triethanolamine | 10 | Tin(IV) | 2.7 | Antimony(III) | 0.3 |
| | | Acid | | | | Chloride•Pentahydrate | | Chloride | |
| | 7 | Acetic | 36 | Tripropylamine | 24 | Tin(IV) | 2.7 | Antimony(III) | 0.3 |
| | | Acid | | | | Chloride•Pentahydrate | | Chloride | |
| | 8 | Acetic | 40 | Tripropylamine | 20 | Tin(IV) | 2.7 | Antimony(III) | 0.3 |
| | | Acid | | | | Chloride•Pentahydrate | | Chloride | |
| | 9 | Acetic | 36 | n-Butylamine | 24 | Tin(IV) | 2.7 | Antimony(III) | 0.3 |
| | | Acid | | | | Chloride•Pentahydrate | | Chloride | |
| | 10 | Acetic | 40 | n-Butylamine | 20 | Tin(IV) | 2.7 | Antimony(III) | 0.3 |
| | | Acid | | | | Chloride•Pentahydrate | | Chloride | |
| | 11 | Acetic | 50 | n-Butylamine | 10 | Tin(IV) | 2.7 | Antimony(III) | 0.3 |
| | | Acid | | | | Chloride•Pentahydrate | | Chloride | |

Heating Treatment

| | | Heating | Holding |
|---|---|---|---|
| | | Temperature | Time |
| | | (° C.) | (Hours) |
| Invention | 1 | 200 | 5 |
| Example | 2 | 200 | 5 |
| | 3 | 200 | 5 |
| | 4 | 200 | 5 |
| | 5 | 200 | 5 |
| | 6 | 200 | 5 |
| | 7 | 200 | 5 |
| | 8 | 200 | 5 |
| | 9 | 200 | 5 |
| | 10 | 200 | 5 |
| | 11 | 200 | 5 |

### Invention Examples 12 and 13

1.99 g of potassium stannate was dissolved in 10 mL of water, and 0.40 g of antimony(V) chloride and 2 mL of acetic acid were added thereto to obtain a raw material paste. The raw material paste was washed with water, and then 10 mL of 0.7 mol % methylamine aqueous solution was added thereto to obtain a raw material suspension.

The raw material suspension was subjected to heating treatment under predetermined conditions (in Invention Example 12, the raw material suspension was held at 200° C. for 6 hours, and in Invention Example 13, the raw material suspension was held at 230° C. for 2 hours) to produce metal oxide fine particles consisting of antimony-doped tin oxide (doping concentration: 16 atom %).

### Invention Example 14

4.55 mmol of indium octylate, 0.51 mmol of tin(II) octylate, 41.94 mmol of oleylamine, and 158.38 mmol of octyl ether were mixed, and the mixture was subjected to heating treatment by being held at 80° C. for 1 hour in a vacuum (100 kPa or less). Thereafter, under nitrogen atmosphere, the mixture was subjected to heating treatment by being held at 150° C. for 1 hour and then held at 280° C. for 1 hour. Thereby, metal oxide fine particles consisting of tin-doped indium oxide (doping concentration: 10 atom %) were produced.

The indium octylate had hygroscopicity and the mixture contained water as solvent.

### Comparative Examples 1 and 2

92 g of 5 mass % tin(IV) chloride solution, 14 g of 17 mass % hydrochloric acid, and antimony(III) chloride solution at a ratio of 5 to 30 atom % (Comparative Example 1:5 atom %, Comparative Example 2:18 atom %) with respect to tin were mixed, and the mixed liquid was added dropwise to 1 L of water kept at 60° C. together with 25 mass % sodium hydroxide solution. The pH was kept in the range of 5 to 6. The obtained hydroxide was decanted to remove residual salts, filtered, dried, and then sintered in the atmosphere at temperature of 700° C. to 900° C. for 2 hours.

### Comparative Example 3

55 mL of indium chloride aqueous solution and 4.38 g of tin(II) chloride dihydrate were mixed, the obtained mixed aqueous solution and ammonia aqueous solution were simultaneously added dropwise to 500 mL of water, the pH was adjusted to 7, and the mixture was reacted at a liquid temperature of 30° C. for 30 minutes. The precipitated hydroxide was repeatedly washed with ion exchange water until the electric conductivity of the supernatant reached 100 μS/cm or less. The hydroxide was separated by filtration, and the hydroxide was dried at 110° C. overnight, and then sintered at 550° C. for 3 hours in the atmosphere.

The aggregate obtained by sintering was loosened by crushing, and a bright-yellow tin-doped indium oxide powder was obtained. The tin-doped indium oxide powder was put into surface treatment liquid obtained by mixing anhydrous ethanol and distilled water (weight ratio of ethanol: distilled water=95:5) and the tin-doped indium oxide powder was impregnated therein. Next, the mixture was put into a glass laboratory dish and subjected to heating treatment at 330° C. for 2 hours under nitrogen gas atmosphere to obtain a targeted tin-doped indium oxide powder.

For the metal oxide fine particles of Invention Examples 1 to 14 and

Comparative Examples 1 to 3 obtained as described above, each item was evaluated by the following method. The evaluation results are shown in Table 2.

### Transmission Spectrum of Dispersion of Metal Oxide Fine Particles

The metal oxide fine particles were dispersed in one of dispersion mediums shown in Table 2 and the concentration of the metal oxide fine particles was adjusted to 0.7 mass %. In this case, one or more dispersants (alkyl succinate, phosphoric acid ester, or the like) may be appropriately added, and the type and the amount of the dispersants are selected within a range not affecting the transmission spectrum.

The obtained dispersion of metal oxide fine particles was put into a 1 mm cell and a transmission spectrum was measured using a spectrophotometer (UH4150 manufactured by Hitachi High-Tech Corporation). From the measured transmission spectrum, the inclination k₁ was calculated by linearly approximating the transmission spectrum in the wavelength range of 290 nm to 330 nm by the least squares method, and the inclination k₂ was calculated by linearly approximating the transmission spectrum in the wavelength range of 310 nm to 330 nm by the least squares method.

### Primary Particle Diameter of Metal Oxide Fine Particles

An image of the particles was captured at 100000-fold magnification using a transmission electron microscope (JEM-21OF manufactured by JEOL Ltd.). Using image processing software Image J, a primary particle diameter was calculated from the average of particle areas of 50 particles, assuming that all the particles were spherical.

TABLE 2

| | | Metal Oxide Fine Particles | | | | |
|---|---|---|---|---|---|---|
| | | | Transmission Spectrum | | | |
| | | | of Dispersion | | | Primary |
| | | | | k₁ | k₂ | Particle |
| | | | Dispersion | (290 to | (310 to | Diameter |
| | | Material | Medium | 330 nm) | 330 nm) | (nm) |
| Invention | 1 | ATO | Water | 1.07 | 1.09 | 6 |
| Example | 2 | ATO | Water | 1.17 | 1.13 | 7 |
| | 3 | ATO | Water | 1.46 | 1.36 | 6 |
| | 4 | ATO | Water | 1.23 | 1.20 | 7 |
| | 5 | ATO | Water | 1.29 | 1.21 | 7 |
| | 6 | ATO | Water | 1.24 | 1.15 | 7 |
| | 7 | ATO | Water | 1.13 | 1.09 | 5 |
| | 8 | ATO | Water | 1.05 | 0.970 | 5 |
| | 9 | ATO | Water | 1.36 | 1.28 | 5 |
| | 10 | ATO | Water | 1.42 | 1.31 | 7 |
| | 11 | ATO | Water | 0.948 | 1.02 | 9 |
| | 12 | ATO | Water | 1.48 | 1.75 | 4 |
| | 13 | ATO | Water | 1.28 | 2.12 | 5 |
| | 14 | ITO | Toluene | 1.02 | 1.85 | 9 |
| Comparative | 1 | ATO | IPA | 0.749 | 0.846 | 12 |
| Example | 2 | ATO | Toluene | 0.557 | 0.632 | 12 |
| | 3 | ITO | Toluene | 0.612 | 0.930 | 20 |

As shown in Table 2, in Comparative Examples 1 to 3, in the transmission spectrum of the dispersion in which the metal oxide fine particles were dispersed in the dispersion medium at a concentration of 0.7 mass %, the inclination k₁ obtained by linearly approximating the transmission spectrum in the wavelength range of 290 nm to 330 nm by the least squares method was less than 0.90, and the inclination k₂ obtained by linearly approximating the transmission spectrum in the wavelength range of 310 nm to 330 nm by the least squares method was less than 0.95, so that the visible light transmission properties were insufficient.

On the other hand, in Invention Examples 1 to 14, in the transmission spectrum of the dispersion in which the metal oxide fine particles were dispersed in the dispersion medium at a concentration of 0.7 mass %, the inclination k₁ obtained by linearly approximating the transmission spectrum in the wavelength range of 290 nm to 330 nm by the least squares method was 0.90 or more, and the inclination k₂ obtained by linearly approximating the transmission spectrum in the wavelength range of 310 nm to 330 nm by the least squares method was 0.95 or more, so that the visible light transmission properties were excellent.

As described above, according to the present invention, it has been confirmed that it is possible to provide metal oxide fine particles and dispersions of metal oxide fine particles capable of depositing metal oxide films having excellent heat shielding characteristics and visible light transmission properties.

What is claimed is:

1. Metal oxide fine particles,
wherein with regard to a transmission spectrum measured under conditions where the metal oxide fine particles are dispersed in a dispersion medium at a concentration of 0.7 mass % to prepare a dispersion and the dispersion is put into a 1 mm cell, an inclination k₁ obtained by linearly approximating the transmission spectrum in a wavelength range of 290 nm to 330 nm by a least squares method is in a range of 0.90 or more and 1.60 or less.

2. Metal oxide fine particles,
wherein with regard to a transmission spectrum measured under conditions where the metal oxide fine particles are dispersed in a dispersion medium at a concentration of 0.7 mass % to prepare a dispersion and the dispersion is put into a 1 mm cell, an inclination k₂ obtained by linearly approximating the transmission spectrum in a wavelength range of 310 nm to 330 nm by a least squares method is in a range of 0.95 or more and 2.30 or less.

3. The metal oxide fine particles according to claim 1,
wherein a primary particle diameter is in a range of 2.0 nm or more and 50 nm or less.

4. The metal oxide fine particles according to claim 1,
wherein the metal oxide fine particles consist of a tin oxide or a tin oxide containing antimony.

5. The metal oxide fine particles according to claim 1,
wherein the metal oxide fine particles consist of an indium oxide or an indium oxide containing tin.

6. A dispersion of metal oxide fine particles comprising:
the metal oxide fine particles according to claim 1; and
a dispersion medium in which the metal oxide fine particles are dispersed.
